(19) United States
(12) Patent Application Publication
(10) Pub. No.: US 2026/0000234 A1
(43) Pub. Date: Jan. 1, 2026

(54) HYBRID COFFEE DRIPPER

(71) Applicant: Parker Roth, Naples, FL (US)

(72) Inventor: Parker Roth, Naples, FL (US)

(21) Appl. No.: 18/756,199

(22) Filed: Jun. 27, 2024

(51) Int. Cl. A47J 31/06

(52) U.S. Cl. CPC A47J 31/06

(57) ABSTRACT

This innovative coffee dripper features a unique design that accommodates both cone and flat bottom filters. The dripper supports cone filters at an optimal 60-degree angle, while its specialized bottom support geometry and steeper wall angles ensure proper support for flat bottom filters. This dual-functionality enhances brewing performance and versatility, making it ideal for various coffee preparation methods.

### BACKGROUND

Current coffee drippers lack the design to properly support both cone and flat bottom filters, often compromising on performance. There is a need for a coffee dripper that can effectively support both filter types, ensuring optimal brewing quality for each. This innovation forms the basis of my patent.

### SUMMARY OF THE INVENTION

My innovative coffee dripper features a design that supports a cone filter at approximately 60 degrees. It also includes bottom support geometry and steeper wall angles to accommodate a flat bottom filter, ensuring optimal performance for both filter types.

### DESCRIPTION OF THE DRAWINGS

FIG. 1 is a perspective view of an embodiment of a hybrid coffee dripper.

FIG. 2 is a simplified cross-sectional view of an embodiment of a hybrid coffee dripper with a cone filter.

FIG. 3 is a simplified cross-sectional view of an embodiment of a hybrid coffee dripper with a flat bottom filter.

FIG. 4 is a perspective view of an embodiment of a hybrid coffee dripper with a cone filter and beverage container.

FIG. 5 is an exploded perspective view of an embodiment of a hybrid coffee dripper with a cone filter and beverage container.

FIG. 6 is a front cross-sectional view of an embodiment of a hybrid coffee dripper with a cone filter.

FIG. 7 is a perspective view of an embodiment of a hybrid coffee dripper with a flat bottom filter and beverage container.

FIG. 8 is an exploded perspective view of an embodiment of a hybrid coffee dripper with a flat bottom filter and beverage container.

FIG. 9 is a front cross-sectional view of an embodiment of a hybrid coffee dripper with a flat bottom filter.

### DETAILED DESCRIPTION

A few of the preferred embodiments have been illustrated and described in detail. It is understood, however, that numerous modifications can be made without departing from the invention's scope as claimed. Although these embodiments specifically discuss coffee, the invention is applicable to any infusible substance with at least one infusible liquid. Those skilled in the art will recognize that many variations and substitutions may be made, qualifying as equivalents under the patent claims. The specific embodiments described herein are intended only to exemplify the invention and should not be seen as limiting its spirit or scope.

In the figures, not every element is assigned a reference number. Directional terms such as “front,” “rear,” “upper,” “lower,” “bottom,” “top,” and “side” are used to describe the orientation of the components as depicted in the drawings. Those skilled in the art will understand that these orientations may vary during actual use of the invention and are not intended to be limiting.

The hybrid coffee dripper and beverage container are transparent in the drawings. The drawings utilize shading to illustrate depth. The filter, in this embodiment, is paper and is shaded grey; this was done to clearly illustrate how the filter, flat bottom or cone, interacts with the hybrid coffee dripper.

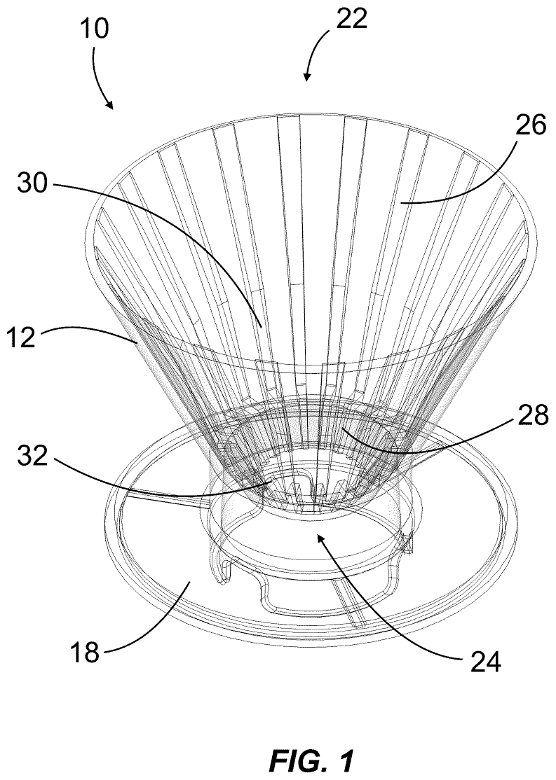

FIG. 1 is a perspective view of an embodiment of a hybrid coffee dripper. The hybrid coffee dripper 10 comprises a dripper body 12, and a base 18 coupled to the dripper body. The base 18 holds the dripper body 12 on top of a beverage container 16. The dripper body 12 holds and supports a filter 14, whether the filter is cone shaped or flat bottomed.

The dripper body 12 has a fluid pathway, which is the route the fluid takes from the fluid entrance 22 to the fluid exit 24. The fluid entrance 22, located at the top of the dripper body 12 and filter 14, accepts hot water poured over a coffee bed in the filter 14. The filter 14 functions as an infusing chamber, allowing the brewing process to take place by holding the coffee grounds and enabling water to pass through, extracting flavors and aromas. The brewed beverage then exits the fluid exit 24 at the bottom of the filter 14 and dripper body 12 into the beverage container 16. The path between the fluid entrance 22 and the fluid exit 24 is the fluid pathway.

This novel coffee dripper incorporates two distinct types of filter support geometry: cone support geometry and flat bottom support geometry. The upper cone support geometry 26, configured as a ridge, is inclined at approximately 60 degrees to support commercially available cone-shaped filters. This upper cone support geometry 26 stabilizes the upper portion of the cone filter, ensuring it maintains its shape during use. Similarly, the lower cone support geometry 28, also configured as a ridge and inclined at approximately 60 degrees, supports the lower portion of the cone filter to preserve its structural integrity during brewing.

The upper flat bottom support geometry 30, in this embodiment, is designed as a ridge with a steeper wall angle compared to the cone support geometry. This upper flat bottom support geometry 30 provides lateral support to the sides or walls of the flat bottom filter. The lower flat bottom support geometry 32, configured as a substantially horizontal ridge, serves as a seat for the bottom flat portion of the flat bottom filter. This lower flat bottom support geometry 32 is critical for maintaining the structural integrity of the flat bottom filter during use, significantly influencing the taste profile of the final brew. The lower flat bottom support geometry 32 is significantly perpendicular to the central access of the dripper body and acts as a seat or bench for the bottom of the flat bottom filter to sit on.

The integration of at least one cone support geometry and at least one lower flat bottom support geometry 32 is a unique innovation, essential to the hybrid coffee dripper's capability to accommodate both cone and flat bottom filters effectively. This combination has not been previously implemented and is vital for the hybrid dripper's functionality.

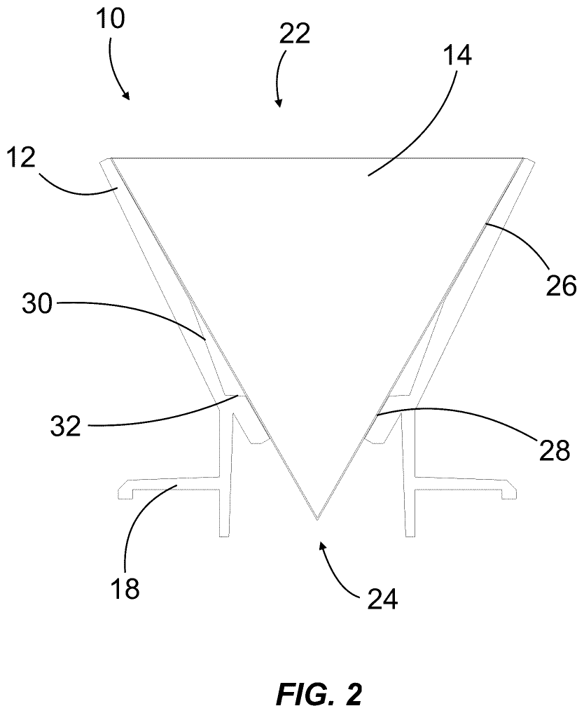

FIG. 2 is a simplified cross-sectional view of an embodiment of a hybrid coffee dripper with a cone-shaped filter. This illustration demonstrates how the filter 14 is positioned within and supported by the dripper body 12. The cone filter is secured by the upper cone support geometry 26 and the lower cone support geometry 28. The upper and lower cone supports are interspersed with the flat bottom filter supports 30 and 32. Despite these interruptions, the structural integrity of the cone filter remains largely unaffected, as the filter can span the gaps created by the bottom supports.

This embodiment features both upper and lower cone support geometries; however, alternative embodiments may include only a single cone support geometry or more than two, depending on design requirements.

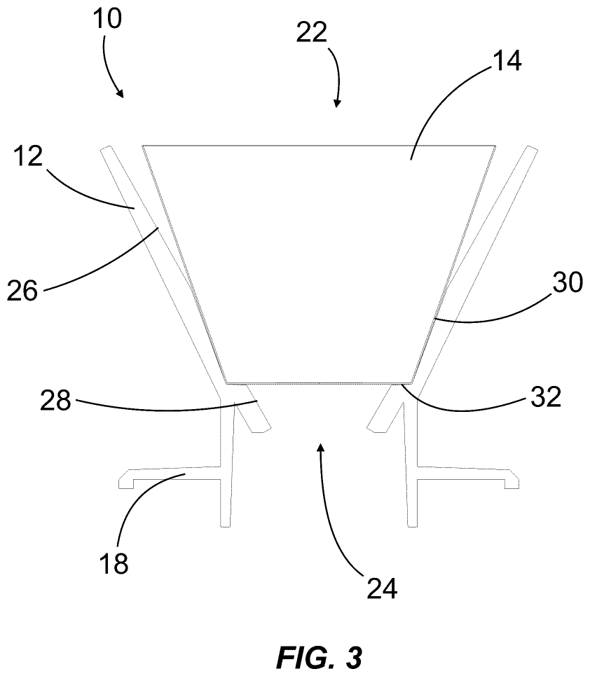

FIG. 3 is a simplified cross-sectional view of the hybrid coffee dripper embodiment from FIG. 2, now illustrated with a flat bottom filter. The flat bottom filter is supported laterally by the upper flat bottom filter support geometry 30, while the base of the filter is supported by the lower flat bottom support geometry 32. This configuration demonstrates how the flat bottom filter can sit within the hybrid coffee dripper without undergoing excessive deformation during use.

In this embodiment, the flat bottom filter is depicted without the wave structures commonly found in many flat bottom filters, such as the Kalita Wave 185. These wave structures may provide additional support either on or between the cone filter geometries. While this embodiment shows both upper and lower flat bottom support geometries, alternative embodiments may feature a single or more than two flat bottom support geometries.

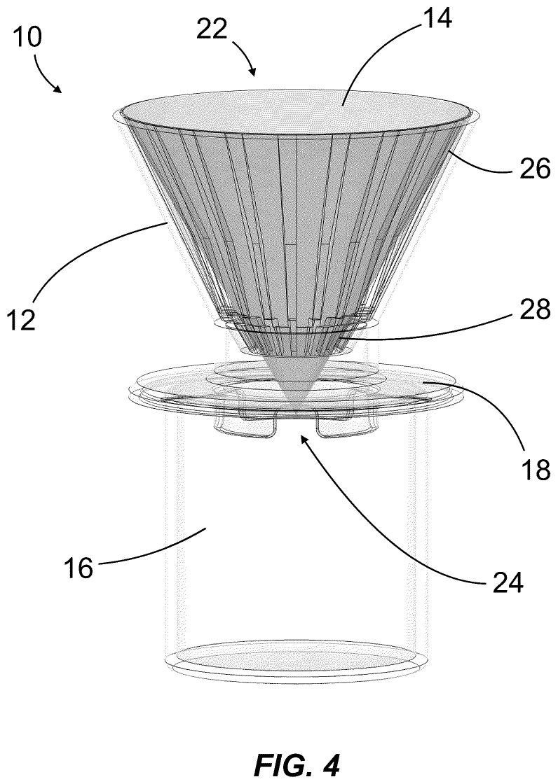

FIG. 4 is a perspective view of an embodiment of a hybrid coffee dripper with a cone filter positioned on a beverage container. In this preferred embodiment, the support geometry consists of a series of ridges designed to manage bypass and ensure an effective flow rate. It should be noted that embodiments without these rib features may still fall within the scope of the claims.

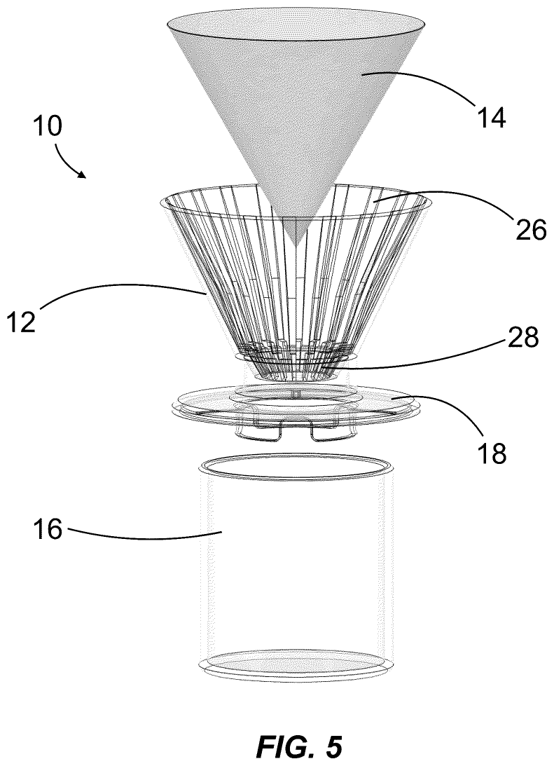

FIG. 5 is an exploded perspective view of the embodiment shown in FIG. 1, illustrating the components of the hybrid coffee dripper, including the filter 14, dripper body 12, base 18, and beverage container 16. This view delineates the spatial relationship and assembly sequence of these components. The filter 14 is seated within the dripper body 12, which, in turn, is supported on the beverage container 16 by the base 18. This configuration ensures proper alignment and stability during use.

Additionally, the base 18 and dripper body 12 are constructed as a unibody structure. Alternatively, they can be fabricated as separate or multiple components that couple together during use. These components may be composed of the same or different materials, including but not limited to metal, plastic, and ceramic. In this specific embodiment, both the base and dripper body are constructed from transparent, BPA-free plastic, ensuring both durability and safety.

The filter 14 in this embodiment is a paper filter, but it can also be fabricated from various other materials such as cloth or metal. The filter's shape can vary, including configurations such as cone-shaped, flat-bottomed, smooth-sided, or ridged-sided. These variations in shape, size, and material remain within the scope of the claims.

For the purposes of this invention, a cone filter is defined as any filter designed for a dripper that conforms to a conical shape. While the paper cone filter is commonly an approximately 60-degree Hario V60 or Cafec filter, it may encompass any cone-shaped filter produced by any brand at various angles.

Similarly, the flat bottom filter is defined as any filter designed for a dripper with a substantially flat bottom. Although commonly represented by the Kalita Wave 155 or 185 paper filters, which may have wave-like or straight walls, the defining characteristic is the significantly flat bottom, which is supported by the lower flat bottom support geometry.

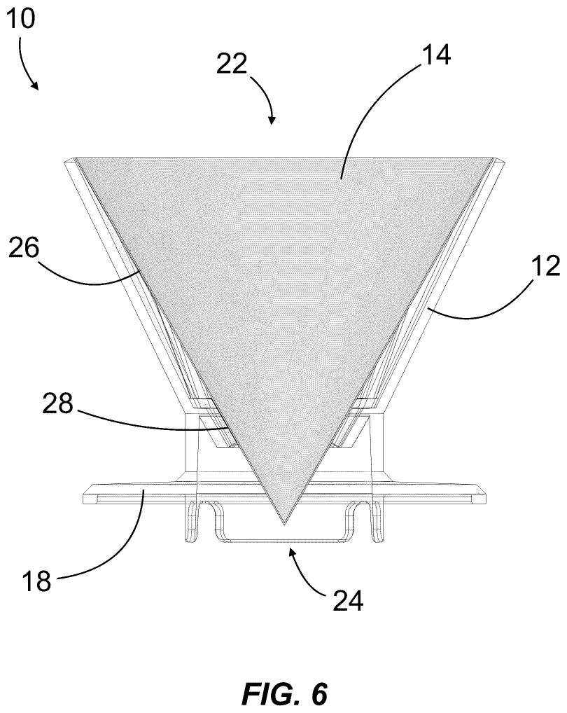

FIG. 6 is a front cross-sectional view of an embodiment of a hybrid coffee dripper 10, illustrating the dripper body 12, filter 14, base 18, and beverage container 16. In this embodiment, the filter is a cone-shaped paper filter.

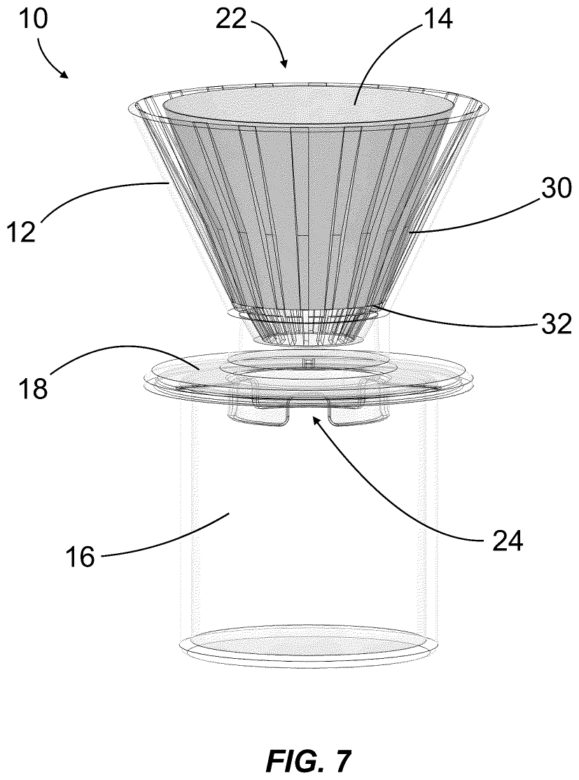

FIG. 7 is a perspective view of an embodiment of a hybrid coffee dripper with a flat bottom filter. The support geometry in this preferred embodiment consists of a series of ridges designed to manage bypass and ensure an effective flow rate. It should be noted that embodiments without these ridge features may still fall within the scope of the claims.

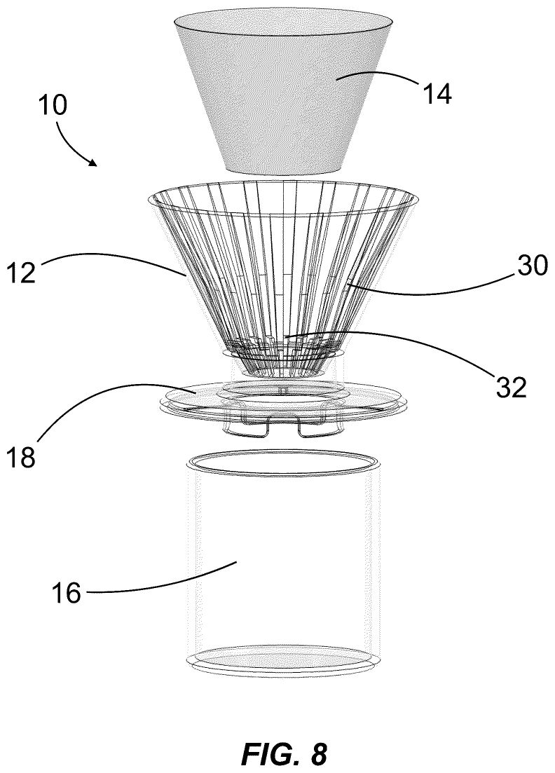

FIG. 8 is an exploded perspective view of an embodiment of a hybrid coffee dripper with a flat bottom filter. This view illustrates the relationship between the filter 14, dripper body 12, base 18, and beverage container 16. The flat bottom filter is seated within the dripper body 12, which is supported on the beverage container 16 by the base 18, similar to the configuration with the cone filter.

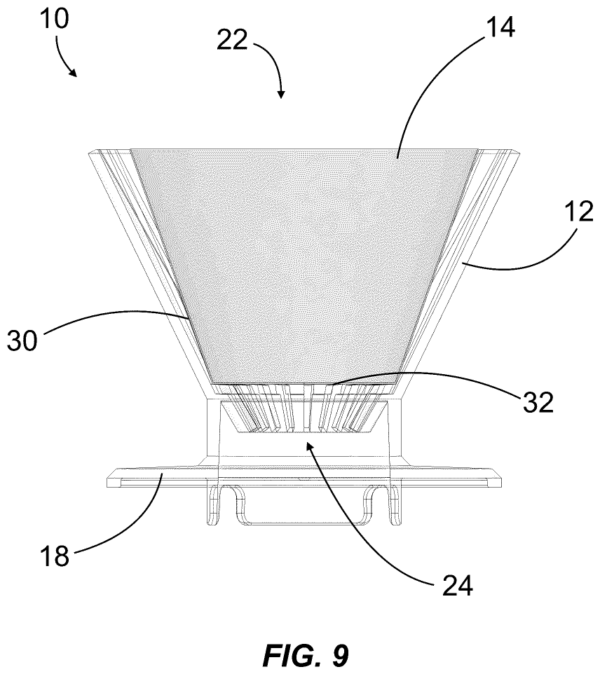

FIG. 9 is a front cross-sectional view of an embodiment of a hybrid coffee dripper 10, illustrating the dripper body 12, filter 14, base 18, and beverage container 16. In this embodiment, the filter is a flat bottom paper filter.

What is claimed is:

1. A hybrid coffee dripper, comprising:
a dripper body and a filter,
said dripper body designed to sit on a beverage container,
said dripper body having at least one fluid pathway,
said dripper body having at least one cone support geometry and at least one flat bottom support geometry,
wherein the flat bottom support geometry provides support for the bottom of the filter.

2. The hybrid coffee dripper of claim 1, wherein the dripper body couples to a base.

3. The hybrid coffee dripper of claim 1, wherein the filter is paper.

4. The hybrid coffee dripper of claim 1, wherein the filter is cloth.

5. The hybrid coffee dripper of claim 1, wherein the filter is metal.

6. The hybrid coffee dripper of claim 1, wherein the dripper body is plastic.

7. The hybrid coffee dripper of claim 1, wherein the dripper body is metal.

8. The hybrid coffee dripper of claim 1, wherein the dripper body is ceramic.

9. The hybrid coffee dripper of claim 1, wherein the dripper body and the base are unibody construction.

10. The hybrid coffee dripper of claim 1, wherein the filter is cone shaped.

11. The hybrid coffee dripper of claim 1, wherein the filter is flat bottom shaped.

12. The hybrid coffee dripper of claim 1, wherein the angle of the cone support geometry is 55 to 65 degrees.

13. The hybrid coffee dripper of claim 1, wherein the upper flat bottom support geometry is steeper than the cone support geometry.

14. A hybrid coffee dripper, comprising:
a dripper body configured to accept a filter,
wherein said dripper body contains at least one cone support geometry and at least one lower flat bottom support geometry.

15. The hybrid coffee dripper of claim 14, wherein the filter is cone shaped.

16. The hybrid coffee dripper of claim 14, wherein the filter is flat bottom shaped.

17. A hybrid coffee dripper, comprising:
a dripper body configured to accept a filter,
said dripper body coupled to a base,
said dripper body having at least one fluid pathway,
said dripper body containing an upper cone support geometry, a lower cone support geometry, an upper flat bottom support geometry, and a lower flat bottom support geometry,
wherein the flat bottom support geometries are between the cone support geometries.

18. The hybrid coffee dripper of claim 17, wherein the filter is cone shaped.

19. The hybrid coffee dripper of claim 17, wherein the filter is flat bottom shaped.

20. The hybrid coffee dripper of claim 17, wherein the lower flat bottom support geometry is largely perpendicular to the vertical center axis of the dripper body.
